(19) United States
(12) Patent Application Publication
(10) Pub. No.: US 2023/0234170 A1
(43) Pub. Date: Jul. 27, 2023

(54) LASER DEVICE

(71) Applicant: FANUC CORPORATION, Yamanashi (JP)

(72) Inventor: Atsushi MORI, Yamanashi (JP)

(73) Assignee: FANUC CORPORATION, Yamanashi (JP)

(21) Appl. No.: 17/999,375

(22) PCT Filed: May 28, 2021
(86) PCT No.: PCT/JP2021/020380

§ 371 Date: Nov. 18, 2022

(30) Foreign Application Priority Data
Jun. 3, 2020 (JP) 2020-097016

(51) Int. Cl. B23K 26/70

(52) U.S. Cl. CPC B23K 26/702

(57) ABSTRACT

The purpose of the present invention is to provide a laser device that makes it possible to minimize condensation in a closed space by means of a simple structure. This laser device comprises a closed space (S4) in which an optical system (31) for transmitting laser light is accommodated and a dew point adjustment flow path (5) of which at least one part is a flow path wall section formed from a transmissive material (51) through which gas molecules including water vapor are transmitted and dust and oil mist are not transmitted. The transmissive material (51) separates the interior of the dew point adjustment flow path (5) and the closed space (S4).

### TECHNICAL FIELD

The present invention relates to a laser device.

### BACKGROUND ART

In a laser device, laser light outputted from a laser source is transmitted, via an optical transmission cable including optical fibers, for example, to a laser processing head. The laser processing head emits the condensed laser light toward a target object to be processed to perform laser processing onto the target object to be processed.

The laser light generated by the laser source is, in the course of transmission to the laser processing head, transmitted through an optical part and reflected by an optical part. When the laser light passes through a boundary between a solid and a gas, or when the laser light passes through a solid, for example, an energy loss occurs. The lost energy is converted into heat. Therefore, to prevent excessive heating and to maintain a normal operating temperature, the laser device is provided with a cooling device configured to use cooling water, for example, to maintain an appropriate temperature.

However, temperature and humidity vary in an installation environment of a laser device. When the temperature in an interior of a housing of the laser device is lower than a dew point in the installation environment of the laser device, condensation occurs on optical parts accommodated in the interior of the housing of the laser device. When condensation occurs on the optical parts, the laser device may lose its original characteristics, and may not operate normally.

Conventionally known technologies for preventing condensation include, for example, a technology for installing a drying agent in a housing (e.g., see Patent Document 1), a technology for installing a drying device in a housing (e.g., see Patent Document 2), and a technology for supplying dry air having a low dew point into a housing (e.g., see Patent Document 3).

Patent Document 1: Japanese Unexamined Patent Application, Publication No. H11-201641

Patent Document 2: Japanese Unexamined Patent Application, Publication No. 2005-61731

Patent Document 3: Japanese Unexamined Patent Application, Publication No. 2013-239696

### DISCLOSURE OF THE INVENTION

### Problems to be Solved by the Invention

With the technology in which a drying agent is installed in a housing, it is necessary to replace the drying agent with a new one on a regular basis. With the technology in which a drying device is installed in a housing, it is difficult to discharge condensed moisture out of the housing. Furthermore, when the drying device is stopped, the condensed moisture may diffuse again inside the housing. With the technology for supplying dry air having a low dew point into a housing, it is difficult to keep the dry air clean, and optical parts may become contaminated.

To prevent condensation, such a method is known that keeps a temperature of cooling water to a temperature higher than a dew point. However, depending on a processing form by laser processing, the dew point may exceed 40° C. If the temperature of cooling water is set to 45° C., the temperature in an interior of a housing may partially exceed 75° C. when performing laser irradiation, and there is such an issue that resin parts in the interior of the housing are unable to withstand operation that continues for a long period of time.

Furthermore, to prevent condensation, such a method is known in which a closed space that is a target portion to be dried is filled with dry air or a gas such as nitrogen or argon, and is then sealed. However, for the assembly of components due to maintenance work or the like, a laser device has seal portions that are sealed with a seal material made of a resin. With such seal portions, minute gaps may occur. Even when the gaps are sealed with seal materials such as gaskets or O-rings, water vapor may still enter, causing condensation to occur from a long-term perspective.

Furthermore, such a method is known in which a gas such as dry air is allowed to flow constantly into a closed space that is a target portion to be dried. However, it is difficult to completely remove dust and oil mist from a gas such as dry air from a technological and economical viewpoint. Therefore, even when a gas such as dry air, which is cleaned to a practical level, is allowed to flow constantly into a closed space, the closed space that is a target portion to be dried is eventually contaminated with dust, oil mist, and/or other substances due to the prolonged inflow.

Therefore, such a laser device has been demanded that makes it possible to solve such conventional issues, and to suppress condensation in a closed space by means of a simple structure.

### Means for Solving the Problems

An aspect of the present disclosure is directed to a laser device including a closed space accommodating an optical system configured to transmit laser light and a dew point adjustment flow path having, at least at one part, a flow path wall section including a permeable material that is permeable to gas molecules including water vapor and impermeable to dust and oil mist. The permeable material separates an interior of the dew point adjustment flow path and the closed space from each other.

### Effects of the Invention

According to the aspect, it is possible to provide such a laser device that makes it possible to suppress condensation in a closed space by means of a simple structure.

### BRIEF DESCRIPTION OF THE DRAWINGS

FIG. 1 is a schematic diagram illustrating an outline configuration of an embodiment of a laser device;

FIG. 2 is a schematic diagram illustrating a first embodiment of a laser light source device of the laser device;

FIG. 3 is a schematic diagram illustrating a first embodiment of a laser processing head of the laser device;

FIG. 4 is a schematic diagram illustrating a second embodiment of the laser processing head of the laser device;

FIG. 5 is a schematic diagram illustrating a third embodiment of the laser processing head of the laser device;

FIG. 6 is a schematic diagram illustrating a fourth embodiment of the laser processing head of the laser device;

FIG. 7 is a schematic diagram illustrating a second embodiment of the laser light source device of the laser device;

FIG. 8 is a schematic diagram illustrating a third embodiment of the laser light source device of the laser device; and

FIG. 9 is a schematic diagram illustrating a fifth embodiment of the laser processing head of the laser device.

### PREFERRED MODE FOR CARRYING OUT THE INVENTION

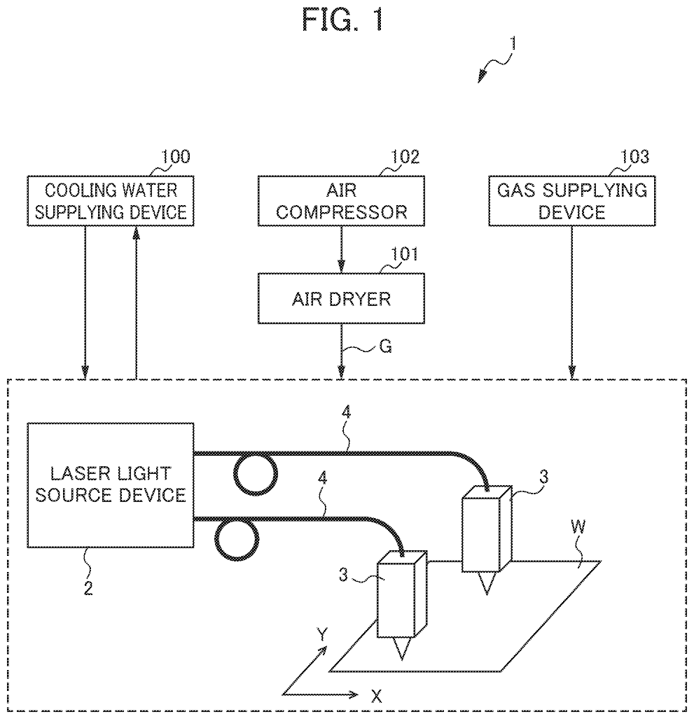

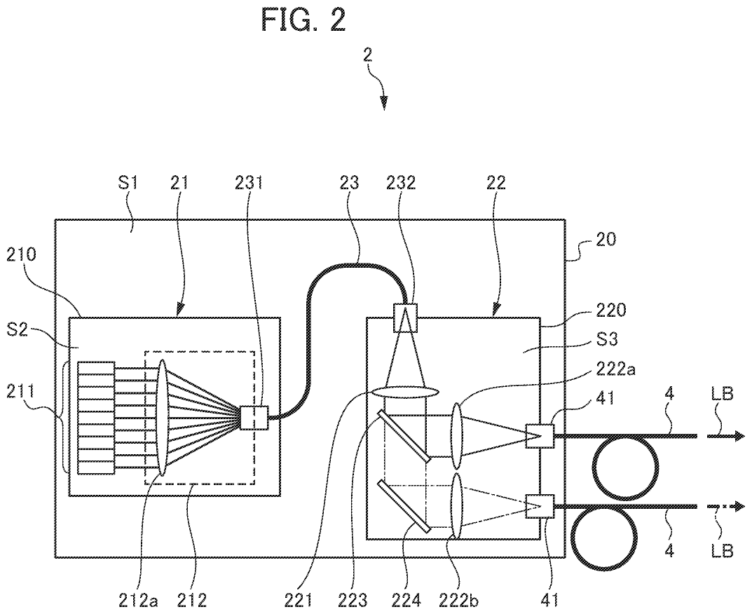

A laser device according to an aspect of the present disclosure will now be described herein with reference to the accompanying drawings. An outline configuration of the laser device will now first be described herein with reference to FIGS. 1 and 2. A laser device 1 illustrated in FIG. 1 includes a laser light source device 2 configured to generated laser light, laser processing heads 3 configured to perform laser processing on a target object to be processed W, and first optical transmission cables 4 constituting light paths configured to allow the laser light to be transmitted.

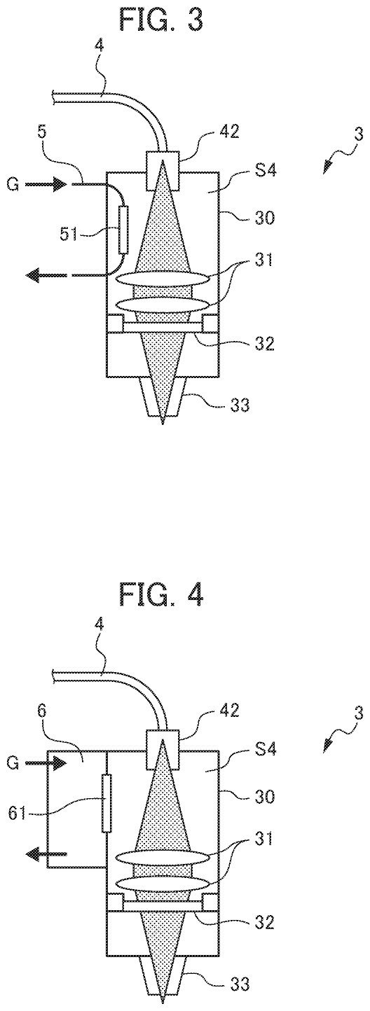

The laser light generated by the laser light source device 2 is transmitted by the first optical transmission cables 4 to the laser processing heads 3. The first optical transmission cables 4 include optical fibers, for example, and are provided between the laser light source device 2 and the laser processing heads 3. Light-incoming ends of the first optical transmission cables 4 are coupled, via light-incoming connectors 41, to the laser light source device 2 (see FIG. 2). Light-outgoing ends of the first optical transmission cables 4 are coupled, via light-outgoing connectors 42, to the laser processing heads 3 (see FIGS. 3 to 6). The light-incoming connectors 41 and the light-outgoing connectors 42 include blocks of quarts glass applied with anti-reflecting coating, for example.

The laser processing heads 3 condense laser light transmitted via the first optical transmission cables 4 and emit laser light LB toward the target object to be processed W to perform processing, such as welding or cutting, onto the target object to be processed W. The target object to be processed W is mounted on a table (not shown) that is movable in two axial directions such as X and Y directions.

The laser device 1 according to the present embodiment is configured to allow laser light generated by the single laser light source device 2 to be separately transmitted, by the two first optical transmission cables 4, 4, to the two laser processing heads 3, 3. Note that the laser device 1 may at least include one laser processing head 3 and one first optical transmission cable 4.

The laser light source device 2 includes, as illustrated in FIG. 2, in a closed space S1 in an interior of a housing 20, a laser source 21, an optical branching device 22, and a second optical transmission cable 23 including optical fibers, for example. The second optical transmission cable 23 is provided between the laser source 21 and the optical branching device 22 to allow laser light to be transmitted from the laser source 21 to the optical branching device 22. A light-incoming end of the second optical transmission cable 23 is coupled, via a light-incoming connector 231, to the laser source 21. A light-outgoing end of the second optical transmission cable 23 is coupled, via a light-outgoing connector 232, to the optical branching device 22. The light-incoming connector 231 and the light-outgoing connector 232 include blocks of quarts glass applied with anti-reflecting coating, for example.

The laser source 21 includes, in a closed space S2 in an interior of a housing 210, a plurality of laser light source sections 211 and a light condensing section 212. As the laser light source sections 211, laser light sources that vary in type, such as CO2 laser, semiconductor laser, yttrium aluminum garnet laser (YAG) laser, and fiber laser, may be used, for example. However, the laser light source sections 211 are not limited to those examples. Laser light emitted from the laser light source sections 211 is condensed, by a light condensing lens 212a provided to the light condensing section 212, into the light-incoming connector 231 of the second optical transmission cable 23. The second optical transmission cable 23 allows the laser light entering the light-incoming connector 231 to be transmitted toward the light-outgoing connector 232. The laser light is emitted from the light-outgoing connector 232 toward the optical branching device 22.

The optical branching device 22 includes, in a closed space S3 in an interior of a housing 220, in an advancing direction of the laser light emitted from the light-outgoing connector 232 of the second optical transmission cable 23, a collimator lens 221, a movable mirror 223, a fixed mirror 224, and light condensing lenses 222a, 222b.

The laser light emitted from the light-outgoing connector 232 toward the closed space S3 in the optical branching device 22 is converted, by the collimator lens 221, into parallel light, and is emitted toward the movable mirror 223. The movable mirror 223 is provided to be movable between a position where laser light emitted from the collimator lens 221 is blocked to be reflected and a position where laser light emitted from the collimator lens 221 is not blocked. When the movable mirror 223 is disposed at the position at which laser light is blocked, laser light reflected by the movable mirror 223 enters, via the light condensing lens 222a, the light-incoming connector 41 of one of the first optical transmission cables 4. When the movable mirror 223 is moved to the position at which laser light is not blocked, laser light emitted from the collimator lens 221 enters the fixed mirror 224. The laser light reflected by the fixed mirror 224 enters, via the light condensing lens 222b, the light-incoming connector 41 of the other one of the first optical transmission cables 4. Thereby, the optical branching device 22 is able to supply laser light transmitted from the laser source 21 via the second optical transmission cable 23 by branching the laser light in a time division manner to either of the two laser processing heads 3, 3.

As illustrated in FIG. 1, the laser device 1 further includes a cooling water supplying device 100, an air dryer 101, an air compressor 102, and a gas supplying device 103. The cooling water supplying device 100 is configured to supply cooling water managed to a constant temperature to a target portion to be cooled in the laser device 1. Thereby, heat generated in the target portion to be cooled is removed, and the target portion to be cooled is kept at a constant temperature. The target portion to be cooled is, specifically, at least one of the laser source 21, the optical branching device 22, the first optical transmission cables 4, the second optical transmission cable 23, and the laser processing heads 3.

The air dryer 101 is configured to generate and supply a medium for adjusting a dew point to a target portion to be adjusted with a dew point in the laser device 1. For the medium for adjusting a dew point, a dry gas G may be used, for example. The air dryer 101 generates the dry gas G that is clean and dried from a gas supplied from the air compressor 102. The dry gas G is air or nitrogen in the form of gas, for example, having a dew point lower than a temperature in a closed space in a housing provided for a target portion to be adjusted with a dew point in the laser device 1. A target portion to be adjusted with a dew point in the laser device 1 is, specifically, a closed space in a housing provided for at least one of the laser source 21, the optical branching device 22, and the laser processing heads 3. A specific structure of supplying the dry gas G from the air dryer 101 to a target portion to be adjusted with a dew point will be described later in detail.

The gas supplying device 103 is configured to supply an assist gas such as argon, helium, or nitrogen that is necessary when performing laser processing such as welding or cutting onto the target object to be processed W by the laser processing heads 3.

Next, a specific configuration when supplying the dry gas G to the laser processing heads 3 will now be described herein with reference to FIGS. 3 to 6. Since the two laser processing heads 3, 3 in the laser device 1 according to the present embodiment have identical structures, one of the laser processing heads 3 will be described with reference to FIGS. 3 to 6.

FIG. 3 illustrates a first embodiment of the laser processing head 3 to which the dry gas G is to be supplied. The laser processing head 3 accommodates, in a closed space S4 in an interior of a housing 30, an optical system configured to allow laser light to be transmitted. Specifically, the closed space S4 accommodates a light condensing optical system 31 including a plurality of lenses and a protective glass 32 that protects the light condensing optical system 31. The light-outgoing connector 42 coupled to the first optical transmission cable 4 is coupled to an upper end of the housing 30. A nozzle 33 configured to emit laser light is provided at a lower end of the housing 30. The closed space S4 is a space sealed between the light-outgoing connector 42 and the protective glass 32. Laser light transmitted by the first optical transmission cable 4 from the laser light source device 2 is emitted from the light-outgoing connector 42 toward the closed space S4 in the laser processing head 3. The laser light is condensed by the light condensing optical system 31 accommodated in the closed space S4, is transmitted through the protective glass 32, and is emitted from the nozzle 33 toward the target object to be processed W.

A pipe 5 constituting a dew point adjustment flow path is attached to the housing 30. The pipe 5 is made of a metal material or a resin material. The pipe 5 is coupled to the air dryer 101, allowing the dry gas G supplied from the air dryer 101 to flow into its interior. The pipe 5 extends from outside of the housing 30 toward again outside of the housing 30, while passing through the closed space S4 in the interior of the housing 30. The pipe 5 passes through the housing 30.

The pipe 5 has, at least at one part, a flow path wall section made of a permeable material 51. Specifically, the flow path wall section lying at least at one part of the pipe 5, which is disposed in the closed space S4 in the housing 30, is made of the permeable material 51. Therefore, the permeable material 51 separates the interior of the pipe 5 into which the dry gas G flows and the closed space S4 from each other.

The permeable material 51 comprises a material that is permeable to gas molecules including water vapor and impermeable to dust and oil mist. The gas molecules including water vapor are gas molecules of oxygen, nitrogen, carbon dioxide, or argon including water vapor, for example. The permeable material 51 is impermeable to dust and oil mist having molecular weights greater than those of the gas molecules including water vapor.

For the permeable material 51 as described above, it is possible to use an organic material or an inorganic material. For the organic material, for example, it is possible to use a functional resin material constituting a membrane material such as hollow fiber membranes and flat membranes or a seal material made of a resin. For the inorganic material, for example, it is possible to use a sintered body made of ceramic or metal having many minute vacancies or a thin metal film having many minute vacancies.

The dry gas G flows constantly from the air dryer 101 into the pipe 5. The dry gas G supplied by the pipe 5 to the laser processing head 3 passes, via the pipe 5, through the closed space S4 in the housing 30 of the laser processing head 3. At this time, due to a difference in water vapor partial pressure between the dry gas G in the interior of the pipe 5 and a gas in the closed space S4, moisture contained in the gas in the closed space S4 permeates through the permeable material 51 to gradually diffuse into the dry gas G in the pipe 5. After that, the dry gas G flowing into the pipe 5 is discharged from the laser processing head 3.

Thereby, the gas in the closed space S4 is gradually dried, lowering the dew point in the closed space S4. As a result, occurrence of condensation in the closed space S4 is suppressed. The dry gas G simply flows into the pipe 5, and is not directly supplied into the closed space S4. Furthermore, the permeable material 51 is impermeable to dust and oil mist. Therefore, the optical parts such as the light condensing optical system 31 and the protective glass 32 accommodated in the closed space S4 may be free from contamination by the dry gas G.

Generally, since the laser processing head 3 is smaller in size and lighter in weight, there may be difficulties in installing a drying agent or a drying device in the interior of the housing 30. Furthermore, the laser processing head 3 is installed at a processing point, meaning that it is placed in a harsh environment. With the configuration described above, it is not necessary to cause the closed space S4 to accommodate a drying agent or a drying device to keep the closed space S4 in the housing 30 of the laser processing head 3 in a dried state, but it is possible to easily suppress condensation in the laser processing head 3. Furthermore, the pipe 5 that is simply disposed in the housing 30 of the laser processing head 3 makes it possible to easily achieve drying of the closed space S4 in the laser processing head 3.

Furthermore, as the dew point in the closed space S4 in the interior of the housing 30 lowers, it is not necessary to raise, in accordance with an ambient environment, the temperature of cooling water supplied from the cooling water supplying device 100 to cool the laser processing head 3. Therefore, it is possible to suppress an increase in temperature in the laser processing head 3 during laser processing, to lower the failure probability, and to delay degradation of the parts.

FIG. 4 illustrates a second embodiment of the laser processing head 3 to which the dry gas G is to be supplied. In this laser processing head 3, a dew point adjustment chamber (first dew point adjustment chamber) 6 constituting a dew point adjustment flow path is provided adjacent to the housing 30. The dew point adjustment chamber 6 is disposed adjacent to the closed space S4 in the housing 30 with a wall section of the housing 30 interposed. An interior of the dew point adjustment chamber 6 is coupled to the air dryer 101, and is filled with the dry gas G supplied from the air dryer 101. After flowing into the dew point adjustment chamber 6, the dry gas G is discharged to outside of the dew point adjustment chamber 6.

The wall section of the housing 30, which separates the interior of the dew point adjustment chamber 6 and the closed space S4 from each other, constitutes a flow path wall section for the dry gas G. At least one part of this flow path wall section is made of a permeable material 61. Therefore, the permeable material 61 separates the interior of the dew point adjustment chamber 6 into which the dry gas G flows and the closed space S4 from each other. The permeable material 61 is identical to the permeable material 51 described above.

After flowing constantly into the dew point adjustment chamber 6 to fill the dew point adjustment chamber 6, the dry gas G from the air dryer 101 is discharged to outside of the dew point adjustment chamber 6. At this time, due to a difference in water vapor partial pressure between the dry gas G in the interior of the dew point adjustment chamber 6 and a gas in the closed space S4, moisture contained in the gas in the closed space S4 permeates through the permeable material 61 to gradually diffuse into the dry gas G in the dew point adjustment chamber 6. After that, the dry gas G is discharged to outside of the dew point adjustment chamber 6.

Thereby, effects similar to those achieved by the laser processing head 3 illustrated in FIG. 3 are achieved. Furthermore, since the dew point adjustment chamber 6 is disposed adjacent to the housing 30 and does not pass through the housing 30, dissimilar to the pipe 5, it is possible to easily install the dew point adjustment chamber 6 to the laser processing head 3.

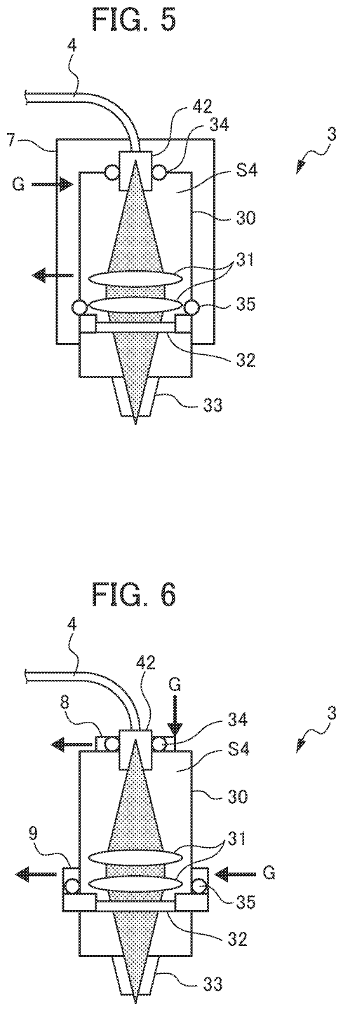

FIG. 5 illustrates a third embodiment of the laser processing head 3 to which the dry gas G is to be supplied. This laser processing head 3 is provided with a dew point adjustment chamber (second dew point adjustment chamber) 7 constituting a dew point adjustment flow path to cover around the housing 30. The dew point adjustment chamber 7 covers around an outer side of the housing 30 across at least a region provided with the closed space S4 in the interior of the housing 30. Thereby, the dew point adjustment chamber 7 serves as an outer shell of the closed space S4. The dew point adjustment chamber 7 is covering around the outer side of the housing 30, from the protective glass 32 in the laser processing head 3 to the light-outgoing connector 42. An interior of the dew point adjustment chamber 7 is coupled to the air dryer 101, and is filled with the dry gas G supplied from the air dryer 101. After flowing into the dew point adjustment chamber 7, the dry gas G is discharged to outside of the dew point adjustment chamber 7.

A gap between the light-outgoing connector 42 of the first optical transmission cable 4 coupled to the laser processing head 3 and the housing 30 is sealed with a gasket 34 that is a seal material made of a resin. A gap between the protective glass 32 and the housing 30 is sealed with a gasket 35 that is a seal material made of a resin. These gaskets 34, 35 are each made of a permeable material that is permeable to gas molecules including water vapor and impermeable to dust and oil mist. The gaskets 34, 35 separate the dew point adjustment chamber 7 and the closed space S4 in the interior of the housing 30 from each other.

After flowing constantly into the dew point adjustment chamber 7 to fill the dew point adjustment chamber 7, the dry gas G from the air dryer 101 is discharged to outside of the dew point adjustment chamber 7. At this time, due to a difference in water vapor partial pressure between the dry gas G in the interior of the dew point adjustment chamber 7 and a gas in the closed space S4, moisture contained in the gas in the closed space S4 permeates through the gaskets 34, 35 each made of the permeable material to gradually diffuse into the dry gas G in the dew point adjustment chamber 7. After that, the dry gas G is discharged to outside of the dew point adjustment chamber 7.

Thereby, effects similar to those achieved by the laser processing head 3 illustrated in FIG. 3 are achieved. Furthermore, since the outer side of the housing 30 of the laser processing head 3 is covered by the dew point adjustment chamber 7, entry of dust, moisture, and other foreign materials into the laser processing head 3 from outside is further prevented. Furthermore, since the gaskets 34, 35 originally provided to the laser processing head 3 are available as permeable materials, it is not necessary to newly provide permeable materials.

FIG. 6 illustrates a fourth embodiment of the laser processing head 3 to which the dry gas G is to be supplied. This laser processing head 3 is provided with dew point adjustment chambers (third dew point adjustment chambers) 8, 9 constituting dew point adjustment flow paths to separately cover the gasket 34 sealing a gap between the light-outgoing connector 42 and the housing 30 and the gasket 35 sealing a gap between the protective glass 32 and the housing 30. The gaskets 34, 35 are respectively accommodated in interiors of dew point adjustment chambers 8, 9. The gaskets 34, 35 separate the dew point adjustment chambers 8, 9 and the closed space S4 in the interior of the housing 30 from each other. The interiors of the dew point adjustment chambers 8, 9 are coupled to the air dryer 101, and are filled with the dry gas G supplied from the air dryer 101. After flowing into the dew point adjustment chambers 8, 9, respectively, the dry gas G is discharged to outside of the dew point adjustment chambers 8, 9.

The dry gas G from the air dryer 101 flows constantly into the dew point adjustment chambers 8, 9, and is discharged to outside of the dew point adjustment chambers 8, 9. At this time, due to a difference in water vapor partial pressure between the dry gas G in the interiors of the dew point adjustment chambers 8, 9 and a gas in the closed space S4, moisture contained in the gas in the closed space S4 permeates through the gaskets 34, 35 each made of the permeable material to gradually diffuse into the dry gas G in the dew point adjustment chambers 8, 9. After that, the dry gas G is discharged to outside of the dew point adjustment chambers 8, 9.

Thereby, the gas in the closed space S4 in the laser processing head 3 is gradually dried, lowering the dew point in the closed space S4. As a result, occurrence of condensation in the closed space S4 is suppressed. Therefore, effects similar to those achieved by the laser processing head 3 illustrated in FIG. 3 are achieved. For example, when the dry gas G with a dew point of −15° C. was allowed to flow constantly into the dew point adjustment chambers 8, 9, respectively, at a flow rate of 1 L/min, it was possible to lower the dew point in the closed space S4 to −5° C. after five days. Furthermore, since respective sizes of the dew point adjustment chambers 8, 9 only need to be large enough to respectively accommodate the gaskets 34, 35, it does not increase the laser processing head 3 in size. Furthermore, since the gaskets 34, 35 originally provided in the laser processing head 3 are utilized as permeable materials, it is not necessary to newly provide permeable materials to the laser processing head 3.

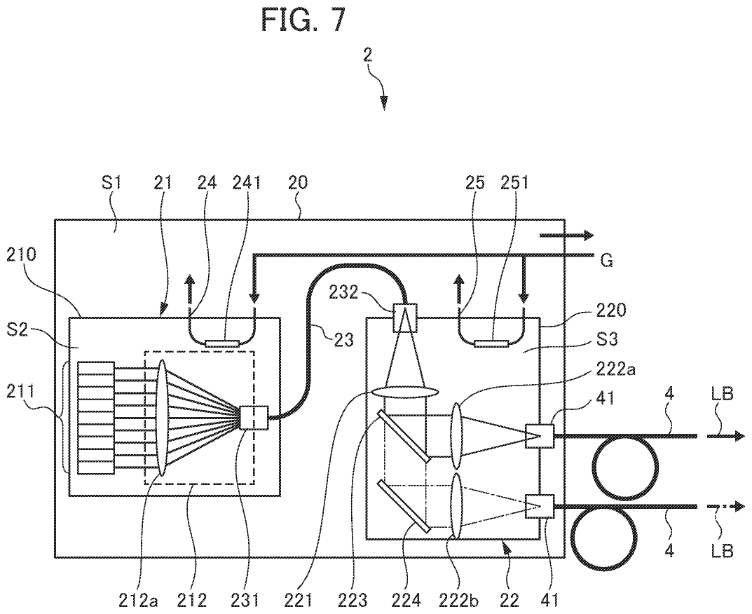

FIG. 7 illustrates a second embodiment of the laser light source device 2 to which the dry gas G is to be supplied. In this laser light source device 2, pipes 24, 25 constituting dew point adjustment flow paths are respectively attached to the laser source 21 and the optical branching device 22. The pipes 24, 25 each have a configuration similar to that of the pipe 5 illustrated in FIG. 3. The pipes 24, 25 are both coupled to the air dryer 101, allowing the dry gas G supplied from the air dryer 101 to flow into respective interiors. The pipe 24 extends from outside of the housing 20 of the laser light source device 2 toward again outside of the housing 210, while passing, via the closed space Sl, through the housing 210 of the laser source 21. The pipe 25 extends from outside of the housing 20 of the laser light source device 2 toward again outside of the housing 220, while passing, via the closed space Sl, through the housing 220 of the optical branching device 22. The dry gas G discharged from the pipes 24, 25 is discharged to outside of the housing 20, via the closed space S1 in the interior of the housing 20 of the laser light source device 2.

Similar to the case of the pipe 5, flow path wall sections each lying at least at one part of each of the pipes 24, 25, which are respectively disposed in the closed spaces S2, S3 in the housings 210, 220, are made of permeable materials 241, 251. Therefore, the permeable materials 241, 251 respectively separate the interiors of the pipes 24, 25 into which the dry gas G flows and the closed spaces S2, S3 from each other.

The dry gas G flows constantly from the air dryer 101 into the pipes 24, 25 in the laser light source device 2. The dry gas G supplied by the pipes 24, 25 to the laser source 21 and the optical branching device 22 passes, via the pipes 24, 25, through the closed space S2 in the housing 210 of the laser source 21 and the closed space S3 in the housing 220 of the optical branching device 22. At this time, due to a difference in water vapor partial pressure between the dry gas G in the interiors of the pipes 24, 25 and gases in the closed spaces S2, S3, moisture contained in the gases in the closed spaces S2, S3 permeates through the permeable materials 241, 251 to gradually diffuse into the dry gas G in the pipes 24, 25. After flowing into the pipes 24, 25 and being once discharged into the closed space S1 in the housing 20 of the laser light source device 2, the dry gas G is discharged to outside of the laser light source device 2.

Thereby, without contaminating the closed spaces S2, S3 in the laser source 21 and the optical branching device 22 by the dry gas G, it is possible to suppress the occurrence of condensation in the closed spaces S2, S3. For example, when the dry gas G with a dew point of −18° C. was allowed to flow constantly into the closed spaces S3, S4 via the pipes 24, 25, respectively, at a flow rate of 5 L/min, it was possible to lower the dew point of the gas in the closed spaces S2, S3 to −15° C. even when the dew point in the ambient environment was 27° C.

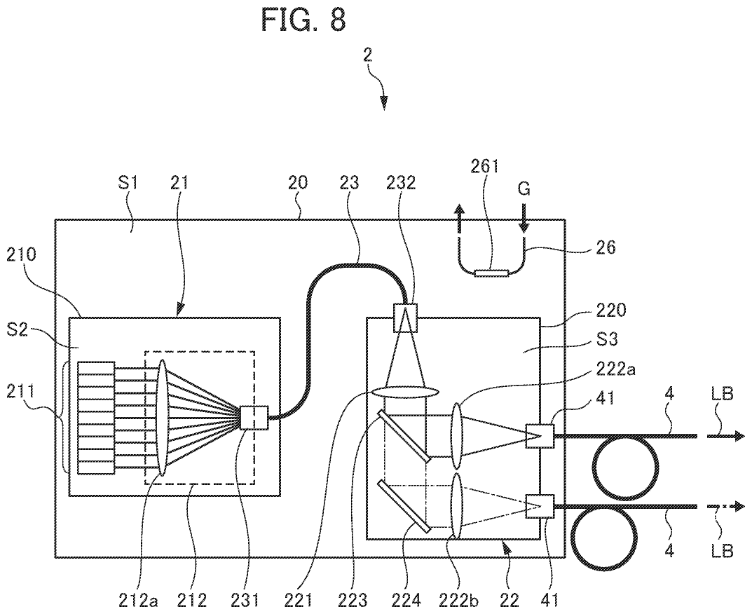

FIG. 8 illustrates a third embodiment of the laser light source device 2 to which the dry gas G is to be supplied. A pipe 26 constituting a dew point adjustment flow path is attached to the housing 20 of this laser light source device 2. The pipe 26 has a configuration similar to that of the pipe 5 illustrated in FIG. 3, and is coupled to the air dryer 101, allowing the dry gas G supplied from the air dryer 101 to flow into its interior. The pipe 26 passes through the housing 20 of the laser light source device 2 and extends toward again outside of the housing 20.

Similar to the case of the pipe 5, a flow path wall section lying at least at one part of the pipe 26 disposed in the closed space S1 in the housing 20 is made of a permeable material 261. Therefore, the permeable material 261 separates the interior of the pipe 26 into which the dry gas G flows and the closed space S1 from each other.

The dry gas G flows constantly from the air dryer 101 into the pipe 26 in the laser light source device 2. The dry gas G supplied by the pipe 26 to the laser light source device 2 passes, via the pipe 26, through the closed space S1 in the housing 20 of the laser light source device 2. At this time, due to a difference in water vapor partial pressure between the dry gas G in the interior of the pipe 26 and a gas in the closed space S1, moisture contained in the gas in the closed space S1 permeates through the permeable material 261 to gradually diffuse into the dry gas G in the pipe 26. The dry gas G is discharged, via the pipe 26, to outside of the laser light source device 2. Thereby, without contaminating the closed space S1 in the laser light source device 2 by the dry gas G, it is possible to suppress the occurrence of condensation in the closed space S1.

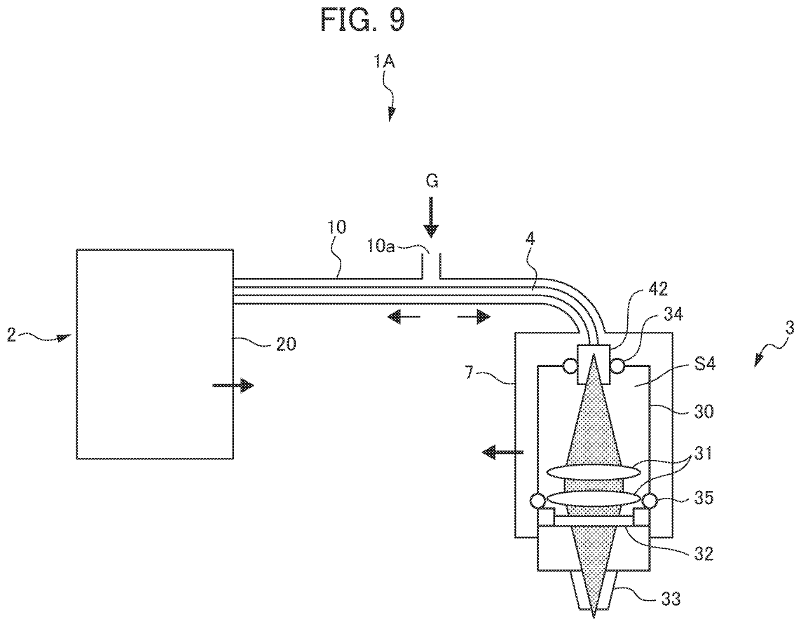

FIG. 9 illustrates a fifth embodiment of the laser processing head 3 to which the dry gas G is to be supplied. In a laser device lA illustrated in FIG. 9, the laser processing head 3 is provided, similar to the laser processing head 3 illustrated in FIG. 5, on the outer side of the housing 30 of the laser processing head 3, with a dew point adjustment chamber 7 covering around the housing 30 to form the outer shell of the closed space S4. However, it differs from the laser processing head 3 illustrated in FIG. 5 in that the first optical transmission cable 4 allowing laser light to be transmitted from the laser light source device 2 to the laser processing head 3 is provided with a sheath member 10 covering an outer side of the first optical transmission cable 4.

The sheath member 10 is made of a metal material or a resin material and is formed into a tubular shape. The sheath member 10 couples, in the extending directions of the first optical transmission cable 4, the housing 20 of the laser light source device 2 and the dew point adjustment chamber 7 provided to the laser processing head 3 in between. A space between an inner side of the sheath member 10 and the outer side of the first optical transmission cable 4 is in communication with an interior of the dew point adjustment chamber 7 for the laser processing head 3. This space constitutes a flow path for the dry gas G to be supplied from the air dryer 11. The sheath member 10 is provided with, at its intermediate position, an entry port 10a allowing the dry gas G supplied from the air dryer 11 to be introduced into the inner side of the sheath member 10.

The dry gas G from the air dryer 101 is introduced from the entry port 10a of the sheath member 10 into the inner side of the sheath member 10, is allowed to flow in a space between the sheath member 10 and the first optical transmission cable 4, and is allowed to flow constantly into the dew point adjustment chamber 7. After flowing into the dew point adjustment chamber 7 and filling the dew point adjustment chamber 7, the dry gas G is discharged to outside of the dew point adjustment chamber 7. Therefore, the laser processing head 3 illustrated in FIG. 9 makes it possible to achieve effects similar to those achieved by the laser processing head 3 illustrated in FIG. 5. Since the first optical transmission cable 4 passes through the inner side of the sheath member 10 communicated with the dew point adjustment chamber 7 and is coupled to the light-outgoing connectors 42, it is possible to prevent external air from entering from a portion at which the first optical transmission cable 4 passes through the dew point adjustment chamber 7. For the dew point adjustment chamber 7, it is not necessary to separately provide pipes for introducing the dry gas G into the dew point adjustment chamber 7. Furthermore, since the sheath member 10 covers the outer side of the first optical transmission cable 4 in the extending directions of the first optical transmission cable 4, it is not necessary to provide an installation space for a flow path for the dry gas G in addition to an installation space for the first optical transmission cable 4.

Note that the dry gas G flowing into the inner side of the sheath member 10 may also be supplied to the laser light source device 2 along the sheath member 10. In the interior of the housing 20 of the laser light source device 2, the sheath member 10 may be in communication with the pipes 24, 25 illustrated in FIG. 7, making it possible to supply the dry gas G to the pipes 24, 25. Furthermore, in the interior of the housing 20 of the laser light source device 2, the sheath member 10 may be in communication with the pipe 26 illustrated in FIG. 8, making it possible to supply the dry gas G to the pipe 26.

Furthermore, by allowing the inner side of the sheath member 10 to be in communication with the interior of the housing 20 of the laser light source device 2, the housing 20 is able to configure a dew point adjustment chamber (dew point adjustment flow path) forming an outer shell of the laser source 21 and the optical branching device 22. In that case, at least one part of the housing 210 of the laser source 21 and at least one part of the housing 220 of the optical branching device 22 may be each provided with a permeable material, similar to the permeable material 61 illustrated in FIG. 4. With this configuration, by allowing the dry gas G to be introduced, via the inner side of the sheath member 10, to the closed space S1 in the housing 20, it is possible to allow moisture contained in a gas in the closed space S2 in the laser source 21 and a gas in the closed space S3 in the optical branching device 22, respectively, to permeate through the permeable materials to gradually diffuse into the dry gas G in the closed space S1, making it possible to lower the dew points in the closed spaces S2, S3. Since the sheath member 10 is able to commonly supply the dry gas G to both the laser light source device 2 and the laser processing heads 3, it is possible to reduce the number of installed flow paths for supplying the dry gas G.

The present disclosure is not limited to the embodiments described above and includes modifications and improvements, for example. For example, instead of the configurations of the pipes 24, 25, 26 provided to the laser light source device 2 illustrated in FIGS. 7 and 8, the configurations of the dew point adjustment chambers 6, 7 illustrated in FIGS. 4 and 5 may be applied.

Pressure of the dry gas G supplied from the air dryer 101 may be appropriately adjusted in accordance with the characteristics of a permeable material.

### EXPLANATION OF REFERENCE NUMERALS

1, 1A Laser device

3 Laser processing head

4, 35 Gasket (permeable material)

4 First optical transmission cable (light path)

5, 24, 25, 26 Pipe (dew point adjustment flow path)

51, 61, 241, 251, 261 Permeable material

6 First dew point adjustment chamber (dew point adjustment flow path)

7 Second dew point adjustment chamber (dew point adjustment flow path)

8, 9 Third dew point adjustment chamber (dew point adjustment flow path)

10 Sheath member

S1, S2, S3, S4 Closed space

W Target object to be machined

1. A laser device comprising:
a closed space accommodating an optical system configured to transmit laser light; and
a dew point adjustment flow path having, at least at one part, a flow path wall section including a permeable material that is permeable to gas molecules including water vapor and impermeable to dust and oil mist,
the permeable material separating an interior of the dew point adjustment flow path and the closed space from each other.

2. The laser device according to claim 1, further comprising a laser processing head configured to emit laser light toward a target object to be processed, the laser processing head having the closed space, the laser processing head being provided with the dew point adjustment flow path.

3. The laser device according to claim 1, wherein the dew point adjustment flow path comprises a pipe passing through the closed space.

4. The laser device according to claim 1, wherein the dew point adjustment flow path comprises a first dew point adjustment chamber provided adjacent to the closed space.

5. The laser device according to claim 1, wherein the dew point adjustment flow path comprises a second dew point adjustment chamber provided around the closed space, the second dew point adjustment chamber forming an outer shell of the closed space.

6. The laser device according to claim 5, further comprising:
a light path configured to transmit laser light; and
a sheath member covering an outer side of the light path,
the sheath member having an inner side in communication with the second dew point adjustment chamber,
the inner side of the sheath member forming the dew point adjustment flow path.

7. The laser device according to claim 1, wherein
the permeable material includes a seal material made of a resin, the seal material sealing a housing, and
the dew point adjustment flow path comprises a third dew point adjustment chamber accommodating the seal material made of a resin.

8. The laser device according to claim 1, wherein the permeable material includes a functional resin material.

9. The laser device according to claim 1, wherein the permeable material includes a sintered body made of an inorganic material.

10. The laser device according to claim 1, wherein the permeable material includes a seal material made of an organic material.
